(19) United States
(12) Patent Application Publication
(10) Pub. No.: US 2014/0162862 A1
(43) Pub. Date: Jun. 12, 2014

(54) CORRUGATED PAPERBOARD BOX MAKING MACHINE, AND INTER-SHEET PACING DEVICE THEREFOR

(71) Applicant: Kabushiki Kaisha Isowa, Aichi (JP)

(72) Inventors: Naoki Shimura, Kasugai-shi (JP); Yu Kawaguchi, Wajima-shi (JP); Takayuki Nomura, Komaki-shi (JP); Mitsuhiro Ishizuka, Minokamo-shi (JP)

(73) Assignee: Kabushiki Kaisha Isowa, Aichi (JP)

(21) Appl. No.: 14/083,943

(22) Filed: Nov. 19, 2013

(30) Foreign Application Priority Data
Dec. 7, 2012 (JP) 2012-267749

(51) Int. Cl. B31B 1/14

(52) U.S. Cl. CPC B31B 1/14
USPC 493/56

(57) ABSTRACT

Provided is a corrugated paperboard box making machine which comprises: a cutting device for cutting one corrugated paperboard sheet into a plurality of small-size corrugated paperboard sheets along a direction perpendicular to a predetermined transport direction; a folder-gluer for bending and gluing each of the cut small-size corrugated paperboard sheets; a counter-ejector for stacking the glued small-size corrugated paperboard sheets to form a batch of the small-size corrugated paperboard sheets; and an inter-sheet spacing device for spacing the small-size corrugated paperboard sheets apart from each other, between the folder-gluer and the counter-ejector. The inter-sheet spacing device comprises a transport section for transporting the small-size corrugated paperboard sheets from the folder-gluer to the counter-ejector, and a speed adjustment section for adjusting a transport speed in at least one of the folder-gluey and the transport section so that the transport speed in the transport section becomes greater than that in the folder-gluey.

### TECHNICAL FIELD

The present invention relates to a corrugated paperboard box making machine for applying processes such as printing and slotting in sequence to a corrugated paperboard sheet, and an inter-sheet spacing device therefor.

### BACKGROUND ART

Generally, a corrugated paperboard box making machine is required to be capable of processing various types of corrugated paperboard sheets different in sheet length in a sheet feed direction. In the case of processing a small-size corrugated paperboard sheet having a quite-short sheet length, processes such as printing and slotting are applied in sequence to one corrugated paperboard sheet, and usual punching and sheet cutting by using a die cutter is applied to one corrugated paperboard sheet, so that the one corrugated paperboard sheet is cut into a plurality of small-size corrugated paperboard sheets. This type of corrugated paperboard box making machine configured to cut one corrugated paperboard sheet into a plurality of small-size sheets has been known, as described, for example, in JP-08-018384B (Patent Document 1).

In a corrugated paperboard box making machine described in the Patent Document 1, an inter-sheet spacing and sheet transporting device is disposed between a die cutter and a folder-gluer. The inter-sheet spacing and sheet transporting device comprises an array of pairs of upper and lower feed rolls, wherein one or more of the pairs of upper and lower feed rolls located on a downstream side of the array are configured to be rotated at a speed greater than that of the remaining pairs of upper and lower feed rolls located upstream of the one or more pairs of upper and lower feed rolls, so as to space two small-size corrugated paperboard sheets cut by the die cutter, apart from each other. In the folder-gluer, each of the two small-size corrugated paperboard sheets spaced apart from each other is bent and glued while being transported by a bending belt.

### SUMMARY OF THE INVENTION

### Technical Problem

In the inter-sheet spacing and sheet transporting device, a leading one of the two small-size corrugated paperboard sheets cut by the die cutter is accelerated by the downstreammost-side pairs of upper and lower feed rolls, and moved apart from the trailing small-size corrugated paperboard sheet, so that a given spacing is formed between the two corrugated paperboard sheets. When the small-size corrugated paperboard sheet is accelerated, a transport posture thereof can undergo a change to an oblique posture with respect to a transport direction.

If the small-size corrugated paperboard sheet undergoes a change to an oblique posture, the small-size corrugated paperboard sheet will be transported to the folder-gluer while being kept in the oblique posture. This hinders the folder-gluer from accurately bending the small-size corrugated paperboard sheet, which causes a problem that a defective corrugated paperboard box is produced.

The present invention has been made to solve the above problem in the conventional technique, and an object thereof is to provide a corrugated paperboard box making machine capable of allowing a folder-gluer thereof to accurately bend a small-size corrugated paperboard sheet, and an inter-sheet spacing device for the corrugated paperboard box making machine.

### Solution to the Technical Problem

In order to achieve the above object, according to a first aspect of the present invention, there is provided a corrugated paperboard box making machine which comprises: a cutting device for cutting one corrugated paperboard sheet, to which a plurality of types of processes are applied in sequence while one corrugated paperboard sheet is transported in a predetermined transport direction, into a plurality of small-size corrugated paperboard sheets along a direction perpendicular to the predetermined transport direction; a folder-gluer for bending and gluing the cut small-size corrugated paperboard sheets, while the cut small-size corrugated paperboard sheets are transported; a counter-ejector for stacking the glued small-size corrugated paperboard sheets to form a batch having a predetermined number of the glued small-size corrugated paperboard sheets; and an inter-sheet spacing device for spacing the small-size corrugated paperboard sheets apart from each other, between the folder-gluer and the counter-ejector, wherein the inter-sheet spacing device comprises a transport section for transporting the small-size corrugated paperboard sheets from the folder-gluer to the counter-ejector, and a speed adjustment section for adjusting a transport speed in at least one of the folder-gluey and the transport section so that the transport speed in the transport section becomes greater than that in the folder-gluer.

In the present invention having the above feature, the small-size corrugated paperboard sheets are transported from the folder-gluer to the counter-ejector by the transport section of the inter-sheet spacing device, and, during the transport, the transport speed in at least one of the folder-gluer and the transport section is adjusted by the speed adjustment section so that the transport speed in the transport section becomes greater than that in the folder-gluer. Thus, after the plurality of small-size corrugated paperboard sheets are bended and glued through the folder-gluer, they are spaced apart from each other according to the above adjustment of the transport speed. Therefore, the present invention makes it possible to transport the small-size corrugated paperboard sheet cut by the cutting device, to the folder-gluer without undergoing a change to an oblique posture, and accurately bend the small-size corrugated paperboard sheet. In addition, even if the small-size corrugated paperboard sheet undergoes a change to an oblique posture when it is spaced apart from another small-size corrugated paperboard sheet, the counter-ejector can posturally adjust an edge of the small-size corrugated paperboard sheet having an oblique posture, when forming a batch having a predetermined number of the glued small-size corrugated paperboard sheets, so that there is no risk of developing problems with production of corrugated paperboard sheets.

Preferably, in the corrugated paperboard box making machine of the present invention, the speed adjustment section of the inter-sheet spacing device adjusts the transport speed in the transport section so as to become greater than the transport speed in the folder-gluer.

In the corrugated paperboard box making machine having the above feature, the speed adjustment section of the inter-sheet spacing device adjusts the transport speed in the transport section, so as to become greater than the transport speed of the folder-gluer. This eliminates a need for reducing an operational speed of each of the folder-gluer and a processing device disposed upstream of the folder-gluer, such as the cutting device, so that it becomes possible to maintain a corrugated paperboard sheet production speed at a high value.

Preferably, in the above corrugated paperboard box making machine, the speed adjustment section of the inter-sheet spacing device adjusts the transport speed in the transport section so that the transport speed in the transport section becomes 1.1 to 1.6 times greater than that in the folder-gluer.

In the corrugated paperboard box making machine having the above feature, the speed adjustment section of the inter-sheet spacing device adjusts the transport speed in the transport section so that the transport speed in the transport section becomes 1.1 to 1.6 times greater than that in the folder-gluer, so that it becomes possible to accurately form a given spacing between leading and trailing small-size corrugated paperboard sheets.

Preferably, in the corrugated paperboard box making machine of the present invention, the transport section of the inter-sheet spacing device comprises: a pair of transport rolls disposed on an outlet side of the folder-gluer from which the small-size corrugated paperboard sheet is transferred outside the folder-gluer; a transport conveyer for transporting the small-size corrugated paperboard sheet transferred from the pair of transport rolls, to the counter-ejector; and a drive section for driving each of the pair of transport rolls and the transport conveyer.

In the corrugated paperboard box making machine having the above feature, each of the pair of transport rolls and the transport conveyer is driven by the drive section, and the small-size corrugated paperboard sheet transferred from the pair of transport rolls is transported to the counter-ejector. Thus, in this corrugated paperboard box making machine, the small-size corrugated paperboard sheet transferred from the pair of transport rolls is nipped between the pair of transport rolls, so that it becomes possible to accurately transport the small-size corrugated paperboard sheet at a given transport speed, and accurately form a given spacing between leading and trailing small-size corrugated paperboard sheets.

Preferably, in the above corrugated paperboard box making machine, a length of the transport conveyer is set to be greater than a maximum length of a produceable small-size corrugated paperboard sheet in the transport direction.

In the corrugated paperboard box making machine having the above feature, the length of the transport conveyer is set to be greater than a maximum length of a produceable small-size corrugated paperboard sheet in the transport direction, so that it becomes possible to accurately form a given spacing between leading and trailing small-size corrugated paperboard sheets.

Preferably, in the above corrugated paperboard box making machine, the counter-ejector comprises: a ledge disposed in a liftable and lowerable manner so as to separate the stacked small-size corrugated paperboard sheets as a batch having a predetermined number of the small-size corrugated paperboard sheets; a lifting-lowering drive section for lifting and lowering the ledge; and a lifting-lowering control section for controlling the lifting-lowering drive section so as to adjust a timing at which the ledge starts moving downwardly, in conformity to the adjustment of the transport speed by the speed adjustment section.

In the corrugated paperboard box making machine having the above feature, the lifting-lowering control section controls the lifting-lowering drive section so as to adjust a timing at which the ledge starts moving downwardly, in conformity to the adjustment of the transport speed by the speed adjustment section, so that, even if the small-size corrugated paperboard sheets are adjusted in transport speed by the speed adjustment section, the counter-ejector can reliably separate a given number of the small-size corrugated paperboard sheets.

Preferably, in the above corrugated paperboard box making machine, the lifting-lowering control section of the counter-ejector adjusts the timing at which the ledge starts moving downwardly, in accordance with an actual transport speed of the small-size corrugated paperboard sheet obtained by correcting detection information regarding a transport speed of the transport conveyer, using a predetermined speed correction value.

An actual transport speed of the small-size corrugated paperboard sheet being transported by the transport section of the inter-sheet spacing device is likely to become less than the transport speed of the transport conveyer. However, in the corrugated paperboard box making machine having the above feature, the lifting-lowering control section of the counter-ejector adjusts the timing at which the ledge starts moving downwardly, in accordance with an actual transport speed of the small-size corrugated paperboard sheet obtained by correcting detection information regarding a transport speed of the transport conveyer, using a given speed correction value, so that it becomes possible to start the downward movement of the ledge without causing collision with the small-size corrugated paperboard sheet.

Preferably, in the above corrugated paperboard box making machine, the speed correction value is set to a larger value along with an increase in length of the small-size corrugated paperboard sheet in the transport direction.

In the corrugated paperboard box making machine having the above feature, the speed correction value is set to a larger value along with an increase in length of the small-size corrugated paperboard sheet in the transport direction, so that, although an actual transport speed of the small-size corrugated paperboard sheet tends to become smaller along with an increase in length of the small-size corrugated paperboard sheet in the transport direction, it becomes possible to reliably start the downward movement of the ledge without causing collision with the small-size corrugated paperboard sheet.

According to a second aspect of the present invention, there is provided an inter-sheet spacing device for use in a corrugated paperboard box making machine, wherein the corrugated paperboard box making machine comprises: a cutting device for cutting one corrugated paperboard sheet, to which a plurality of types of processes are applied in sequence while the one corrugated paperboard sheet is transported in a predetermined transport direction, into a plurality of small-size corrugated paperboard sheets along a direction perpendicular to the predetermined transport direction; a folder-gluer for bending and gluing each of the cut small-size corrugated paperboard sheets, while the small-size corrugated paperboard sheets are transported; and a counter-ejector for stacking the glued small-size corrugated paperboard sheets to form a batch having a predetermined number of the glued small-size corrugated paperboard sheets. The inter-sheet spacing device spaces the small-size corrugated paperboard sheets apart from each other, between the folder-gluer and the counter-ejector. The inter-sheet spacing device comprises a transport section for transporting the small-size corrugated paperboard sheets from the folder-gluer to the counter-ejector, and a speed adjustment section for adjusting a transport speed in at least one of the folder-gluer and the transport section so that the transport speed of the transport section becomes greater than that in the folder-gluer.

### BRIEF DESCRIPTION OF THE DRAWINGS

FIG. 1 is a front view illustrating a general structure of a corrugated paperboard box making machine according to one embodiment of the present invention.

FIG. 2 is an enlarged front view illustrating a detailed structure of an inter-sheet spacing device in the corrugated paperboard box making machine according to the embodiment of the present invention.

FIG. 3 is an enlarged front view illustrating a detailed structure of a counter-ejector in the corrugated paperboard box making machine according to the embodiment of the present invention.

FIG. 4 is a block diagram illustrating various control devices in the corrugated paperboard box making machine according to the embodiment of the present invention.

FIG. 5 is a plan view illustrating a normal-size corrugated paperboard sheet LSH transferred from a die cutter in the corrugated paperboard box making machine according to the embodiment of the present invention.

FIG. 6 is a plan view illustrating two small-size corrugated paperboard sheets SSH1, SSH2 transferred from the die cutter in the corrugated paperboard box making machine according to the embodiment of the present invention.

### DESCRIPTION OF EMBODIMENTS

With reference to accompanying drawings, a corrugated paperboard box making machine according to one embodiment of the present invention will now be described. The corrugated paperboard box making machine is designed so that processes such as printing, slotting and punching are applied to a corrugated paperboard sheet.

### <<General Structure>>

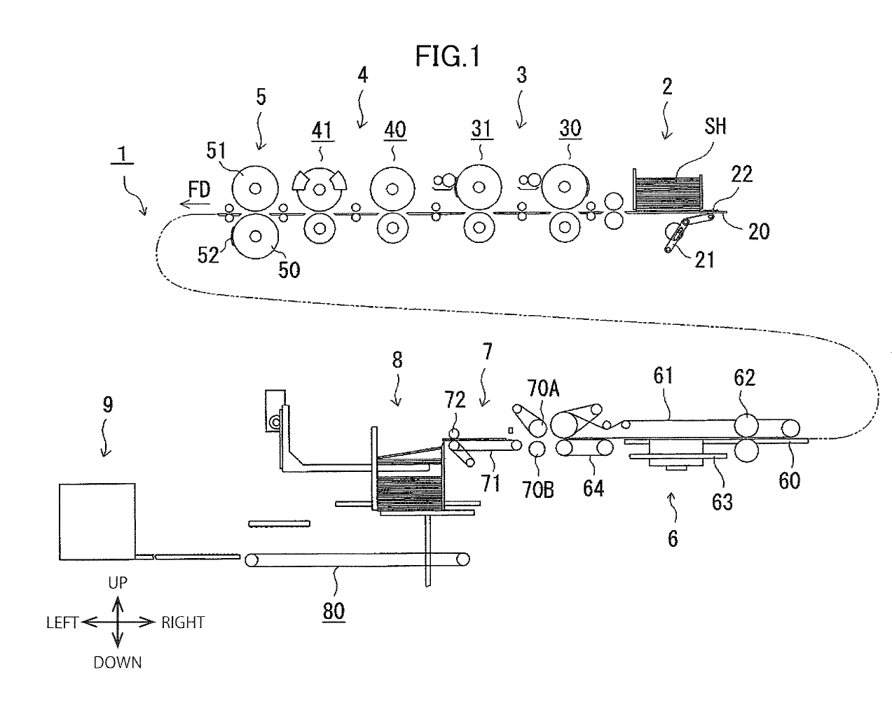

FIG. 1 is a front view illustrating a general structure of the corrugated paperboard box making machine according to the embodiment of the present invention. As illustrated in FIG. 1, the code 1 indicates the corrugated paperboard box making machine, which comprises: a sheet feeding device 2 for feeding a plurality of corrugated paperboard sheets SH one-by-one; a printing device 3 for printing each of the corrugated paperboard sheets SH; a slotter-creaser 4 for adding creases, cutting slots, and forming a joint flap in the corrugated paperboard sheet SH; and a die cutter 5 for forming a punched-out portion having a given shape in the corrugated paperboard sheet SH. The corrugated paperboard box making machine further comprises: a folder-gluer 6 for supplying an adhesive onto the joint flap and bending the corrugated paperboard sheet SH along the creases to bondingly form the bent corrugated paperboard sheet SH into a box structure; an inter-sheet spacing device 7; a counter-ejector 8 for counting the number of the bondingly box-structured corrugated paperboard sheets SH to form a batch consisting of a given number of the bondingly box-structured corrugated paperboard sheets SH, and eject the batch therefrom; and a bundler 9 for bundling the batch together.

The sheet feeding device 2 comprises a table 20 on which a large number of corrugated paperboard sheets SH produced by a corrugating machine are placed. The sheet feeding device 2 also comprises a kicker 22 configured to be reciprocatingly moved by a crank lever mechanism 21. The kicker 22 knicks out a lowermost one of the large number of corrugated paperboard sheets SH to thereby feed the corrugated paperboard sheets SH one-by-one to the printing device 3. The crank lever mechanism 21 is drivenly coupled to a main drive motor MT.

The printing device 3 comprises a plurality of (in this embodiment, two) printing units 30, 31. The printing device 3 provides two-color printing to the corrugated paperboard sheet SH by using the two printing units 30, 31, and supplies the printed corrugated paperboard sheet SH to the slotter-creaser 4. Each of the printing units 30, 31 is drivenly coupled to the main drive motor MT.

The slotter-creaser 4 comprises a creaser unit 40 and a slotter unit 41. The slotter-creaser 4 creases and slotts the printed corrugated paperboard sheet SH, respectively, by using the creaser unit 40 and the slotter unit 41, and forms a joint flap, and supply the processed corrugated paperboard sheet SH to the die cutter 5. Each of the creaser unit 40 and the slotter unit 41 is drivenly coupled to the main drive motor MT.

The die cutter 5 comprises a die cylinder 50, and an anvil cylinder 51 which are disposed across a transport path. A punching die 52 for punching the processed corrugated paperboard sheet SH is attached to a plate-like body made of veneer-core plywood or the like, and the resulting plate-like body is wound around an outer peripheral surface of the die cylinder 50. The anvil cylinder 51 is disposed at a position opposed to the die cylinder 50 across the transport path, and coupled to the main drive motor MT via a conventional drive force transmission mechanism in such a manner as to be rotated according to rotation of the main drive motor MT. The punching die 52 is configured to punch out a hole in the processed corrugated paperboard sheet SH being continuously transported, at a desired position thereof. Each of the die cylinder 50 and the anvil cylinder 51 is drivenly coupled to the main drive motor MT.

The folder-gluer 6 transports the punched corrugated paperboard sheet SH, and, during the transport, apply an adhesive onto the joint flap, and bend the punched corrugated paperboard sheet SH along the creases or the like to adhesively bond the joint flap to a counterpart area of the bent corrugated paperboard sheet SH. The folder-gluer 6 comprises a guide rail 60 along a transport direction of the corrugated paperboard sheet SH. A loop-shaped transport belt 61 is circulatingly movably provided just above the guide rail 60. An adhesive supply device 62, a bending bar 63 and a folding belt 64 are arranged along the guide rail 60 and the transport belt 61.

The folder-gluer 6 supports and transports the punched corrugated paperboard sheet SH formed with the creases and the joint flap, by using the guide rail 60 and the transport belt 61. During the transport of the punched corrugated paperboard sheet SH, the folder-gluer 6 applies an adhesive onto the joint flap by using the adhesive supply device 62, and then bends the adhesive-applied corrugated paperboard sheet SH by using the bending bar 63. Further, the folder-gluer 6 is operable to fold the bent corrugated paperboard sheet SH by using the folding belt 64 to adhesively bond the joint flap to a counterpart area of the bent corrugated paperboard sheet SH, thereby preparing a box-structured corrugated paperboard sheet SH in a folded state. The transport belt 61 is drivenly coupled to a transport drive motor MF1, and the folding belt 64 is drivenly coupled to a folding drive motor MF2.

When a small-size order is executed in which one corrugated paperboard sheet is cut into a plurality of small-size corrugated paperboard sheets, the inter-sheet spacing device 7 performs an inter-sheet spacing operation. On the other hand, when a normal order is executed in which one corrugated paperboard sheet is not cut into a plurality of small-size corrugated paperboard sheets, the inter-sheet spacing device 7 simply transports the one corrugated paperboard sheet between the folder-gluer 6 and the counter-ejector 8 without performing the inter-sheet spacing operation. Details of the inter-sheet spacing device 7 will be described later.

The counter-ejector 8 counts the number of the box-structured corrugated paperboard sheets SH sequentially supplied from the inter-sheet spacing device 7 to form a batch BT consisting of a given number of the box-structured corrugated paperboard sheets SH, and transport the batch BT toward the bundler 9 by using a lower conveyer 80. Details of the counter-ejector 8 will be described later.

The bundler 9 bundles the batch BT transported by the lower conveyer 80, for shipping purposes.

### <Inter-Sheet Spacing Device>

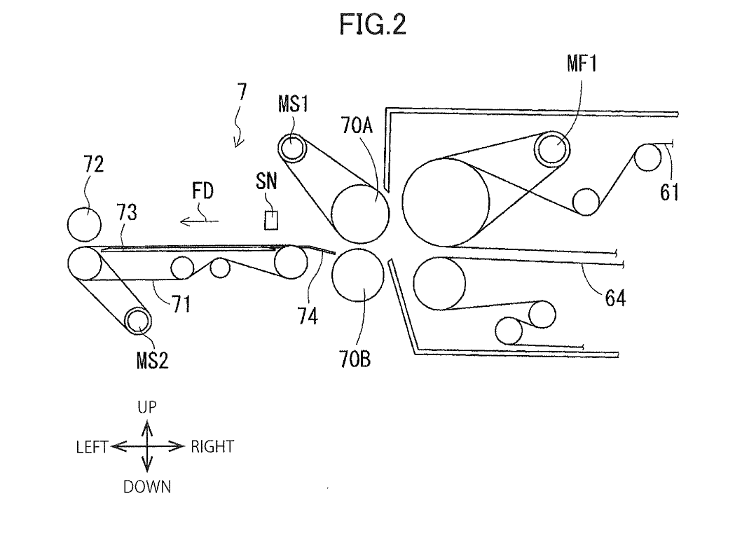

With reference to FIG. 2, the inter-sheet spacing device 7 will be described in detail. FIG. 2 is an enlarged front view illustrating a detailed structure of the inter-sheet spacing device in the corrugated paperboard box making machine according to this embodiment of the present invention. The inter-sheet spacing device 7 comprises a pair of transport rollers 70A, 70B, a transport conveyer 71, and an upper transport roll 72.

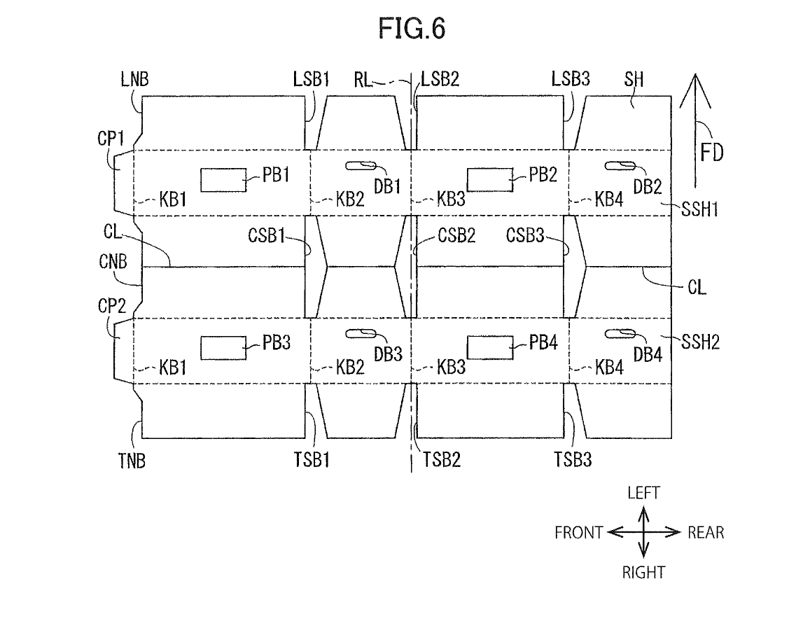

The pair of transport rollers 70A, 70B are disposed adjacent to an outlet of the folder-gluer 6, and nippingly transports the box-structured corrugated paperboard sheet SH transferred from the transport belt 61 and the folding belt 64 of the folder-gluer 6. The transport conveyer 71 is disposed downstream of the transport rollers 70A, 70B in the transport direction FD, and receives the box-structured corrugated paperboard sheet SH from the transport rollers 70A, 70B and transports the received corrugated paperboard sheet SH. The upper transport roll 72 is disposed above and in opposed relation to the transport conveyer 71, at a position on an outlet side of the transport conveyer 71. In cooperation with the transport conveyer 71, the upper transport roll 72 nips the transported corrugated paperboard sheet SH, and transfers the nipped corrugated paperboard sheet SH toward the counter-ejector 8. A horizontal support plate 73 is disposed along a lower surface of an upper belt region of the transport conveyer 71 to horizontally support the upper belt region of the transport conveyer 71 from therebelow. An inclined support plate 74 is disposed to extend inclinedly downwardly from an inlet side of the transport conveyer 71 toward the transport roller 70B. The inclined support plate 74 is configured to guide a leading edge of the box-structured corrugated paperboard sheet transferred from the transport rollers 70A, 70B to prevent the leading edge from getting into under the transport conveyer 71. In this embodiment, a length of the transport conveyer 71 in the transport direction FD is set to be greater than a transport-directional (FD) maximum length of a small-size corrugated paperboard sheet produceable by the corrugated paperboard box making machine 1. The small-size corrugated paperboard sheet is illustrated in FIG. 6 as a small-size corrugated paperboard sheet (SSH1, SSH2).

The pair of transport rollers 70A, 70B are configured to be driven by a roll drive motor MS1. Each of the transport conveyer 71 and the upper transport roll 72 is configured to be driven by a conveyer drive motor MS2.

### <Counter-Ejector>

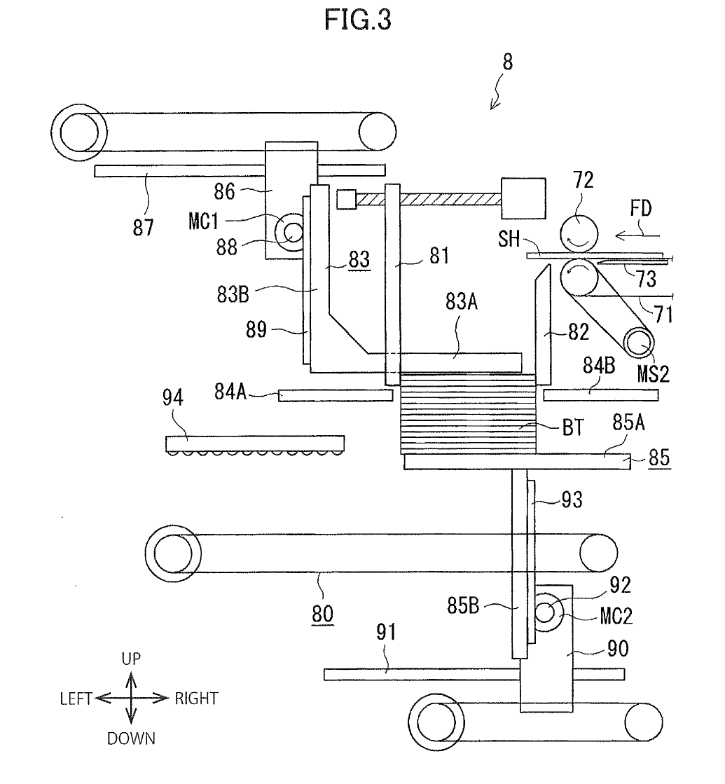

With reference to FIG. 3, the counter-ejector 8 will be described in detail. The counter-ejector 8 comprises a leading-edge contact plate 81, a correction plate 82, a main ledge 83, a pair of auxiliary ledges 84A, 84B, an elevator 85, and a lower conveyer 80. A structure of the counter-ejector 8 is publicly known as described, for example, in JP-2011-230432A. Thus, only a part of the counter-ejector 8 related to the inter-sheet spacing device 7 will be described here.

The leading-edge contact plate 81 is disposed displaceably in a right-left direction to come into contact with a leading edge of the box-structured corrugated paperboard sheet SII transported by and supplied from the inter-sheet spacing device 7 in the given transport direction FD. The leading-edge contact plate 81 is configured to be fixed at a position where a distance between the leading-edge contact plate 81 and the correction plate 82 has a value corresponding to a dimension of the supplied corrugated paperboard sheet SH in the transport direction FD.

The correction plate 82 is located adjacent to and in a certain positional relationship with the inter-sheet spacing device 7, and disposed to come into contact with a trailing edge of the supplied corrugated paperboard sheet SH. The supplied corrugated paperboard sheets SH are stacked in a receiving space defined by the leading-edge contact plate 81, the correction plate 82 and others.

The main ledge 83 has an L shape with a horizontally-extending portion 83A and a vertically-standing portion 83B. A ledge support member 86 is supported by a guide rail 87 movably in the right-left direction. A ledge lifting-lowering motor MC1 is fixed onto the ledge support member 86. A pinion 88 is fixed to an output shaft of the ledge lifting-lowering motor MC1. A rack 89 is fixed to the vertically-standing portion 83B of the main ledge 83. The rack 89 is in mesh engagement with the pinion 88. The vertically-standing portion 83B of the main ledge 83 is supported by a support mechanism provided in the ledge support member 86, in an upwardly and downwardly movable manner. The main ledge 83 is configured to be positioned in the up-down direction according to a rotational direction and a rotational amount of the ledge lifting-lowering motor MC 1.

The auxiliary ledge 84A is disposed to be movable forwardly and backwardly with respect to the leading-edge contact plate 81 and in the right-left direction. The auxiliary ledge 84B is disposed to be movable forwardly and backwardly with respect to the correction plate 82 and in the right-left direction. The auxiliary ledges 84A, 84B are configured to be moved in respective directions causing them to come closer to each other, thereby supporting a lower surface of the supplied corrugated paperboard sheet SH, and then to be moved in respective directions causing them to get away from each other, thereby transferring the supported corrugated paperboard sheet SH to the elevator 85.

The elevator 85 comprises a table 85A on an upper side thereof, and a support rod 85B on a lower side thereof. An elevator support member 90 is supported by a guide rail 91 movably in the right-left direction. An elevator lifting-lowering motor MC2 is fixed onto the elevator support member 90. A pinion 92 is fixed to an output shaft of the elevator lifting-lowering motor MC2. A rack 93 is fixed to the support rod 85B of the elevator 85. The rack 93 is in mesh engagement with the pinion 92. The support rod 85B of the elevator 85 is supported by a support mechanism provided in the elevator support member 90, in an upwardly and downwardly movable manner. The elevator 85 is configured to be positioned in the up-down direction according to a rotational direction and a rotational amount of the elevator lifting-lowering motor MC2.

The lower conveyer 80 is coupled to a belt drive motor (not illustrated), and an upper conveyer 94 is disposed in spaced-apart relation to the lower conveyer 80 by a given distance. The upper conveyer 94 is configured to be moved in an up-down direction by a servomotor (not illustrated) and positioned with respect to the lower conveyer 80, in such a manner that the distance between the upper conveyer 94 and the lower conveyer 80 becomes nearly equal to an up-down directional thickness of the batch BT. In cooperation with upper conveyer 94, the lower conveyer 80 ejects the batch BT to the bundler 9.

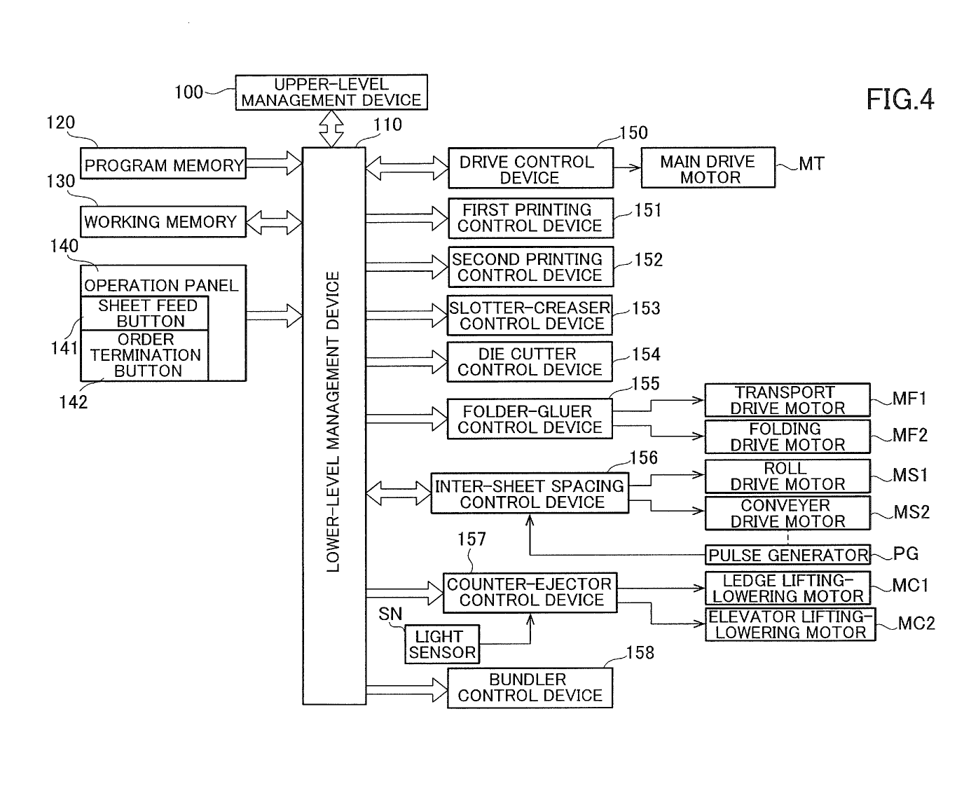

The inter-sheet spacing device 7 is provided with a pulse generator PG (see FIG. 4) for detecting a transport speed of the transport conveyer 71. The pulse generator PG is coupled to the conveyer drive motor MS2, and generates a pulse signal having a frequency according to a rotational speed of the conveyer drive motor MS2.

The counter-ejector 8 is provided with a light sensor SN for counting the number of the corrugated paperboard sheet SH being transported in the inter-sheet spacing device 7. The light sensor SN is disposed adjacent to the inlet side of the transport conveyer 71 as illustrated in FIG. 2, and detects a passing-through of the corrugated paperboard sheet SH.

### <<Control System>>

Next, with reference to FIG. 4, various control devices in the corrugated paperboard box making machine 1 according to this embodiment of the present invention will be described. FIG. 4 is a block diagram illustrating various control devices in the corrugated paperboard box making machine according to this embodiment of the present invention.

As illustrated in FIG. 4, an upper-level management device 100 and a lower-level management device 110 are provided to generally manage processes for corrugated paperboard sheets in the corrugated paperboard box making machine 1. In this embodiment, the upper-level management device 100 stores therein a management plan for executing a large number of orders in a predetermined sequence. The upper-level management device 100 transmits control instruction information regarding a rotational speed of the main drive motor MT, a size of a corrugated paperboard sheet, the number of corrugated paperboard sheets to be processed, etc., to the lower-level management device 110, for each order.

According to the control instruction information transmitted from the upper-level management device 100, the lower-level management device 110 controls operations of drive sections such as the main drive motor MT, and perform a management control such as counting the number of processed corrugated paperboard sheets and transmitting resulting data to the upper-level management device 100. The lower-level management device 110 is connected to a program memory 120, and a working memory 130, so that it makes up a computer for controlling the corrugated paperboard box making machine 1 according to this embodiment, in cooperation with these memories. The program memory 120 is a memory fixedly storing therein a control program for controlling the entire corrugated paperboard box making machine 1, given set values including a speed-up rate and a speed correction value, etc. The working memory 130 is a memory configured to, when the control program is executed, temporarily store therein a variety of information transmitted from the upper-level management device 100 and calculation results.

The lower-level management device 110 is connected to an operation panel 140. The operation panel 140 has a sheet feed button 141, and an order termination button 142. The sheet feed button 141 is manually operated to start feeding of corrugated paperboard sheets from the sheet feeding device 2. The order termination button 142 is manually operated to terminate a currently executed order.

The lower-level management device 110 is connected to each of a drive control device 150, first and second printing control devices 151, 152, a slotter-creaser control device 153, a die cutter control device 154, a folder-gluer control device 155, an inter-sheet spacing control device 156, a counter-ejector control device 157, and a bundler control device 158. According to the control instruction information from the lower-level management device 110, the drive control device 150 controls drive and stop of the main drive motor MT, and the rotational speed thereof. According to the control instruction information from the lower-level management device 110, each of the first and second printing control devices 151, 152 controls an operation of a respective one of the printing units 30, 31. According to the control instruction information from the lower-level management device 110, the slotter-creaser control device 153 controls operations of the creaser unit 40 and the slotter unit 41. According to the control instruction information from the lower-level management device 110, the die cutter control device 154 controls an operation of the die cutter 5.

According to the control instruction information from the lower-level management device 110, the folder-gluer control device 155 controls drive and stop of each of the transport drive motor MF1, the folding drive motor MF2 and other drive motors used for the folder-gluer 6, and a rotational speed thereof. According to the control instruction information from the lower-level management device 110, the inter-sheet spacing control device 156 controls drive and stop of each of the roll drive motor MS1 and the conveyer drive motor MS2, and a rotational speed thereof. The inter-sheet spacing control device 156 also receives a pulse signal from the pulse generator PG, and, based on a frequency of the received pulse signal, supply speed detection information regarding the transport speed of the transport conveyer 71, to the lower-level management device 110. The counter-ejector control device 157 receives a detection signal from the light sensor SN for detecting a passing-through of the corrugated paperboard sheet SH, and then, according to the control instruction information from the lower-level management device 110, and the detection signal from the light sensor SN, to control drive and stop of each of the ledge lifting-lowering motor MC1, the elevator lifting-lowering motor MC2 and other drive motors used for the counter-ejector 8, and a rotational speed thereof. According to the control instruction information from the lower-level management device 110, the bundler control device 158 controls an operation of the bundler 9.

### <<Operation of Embodiment>>

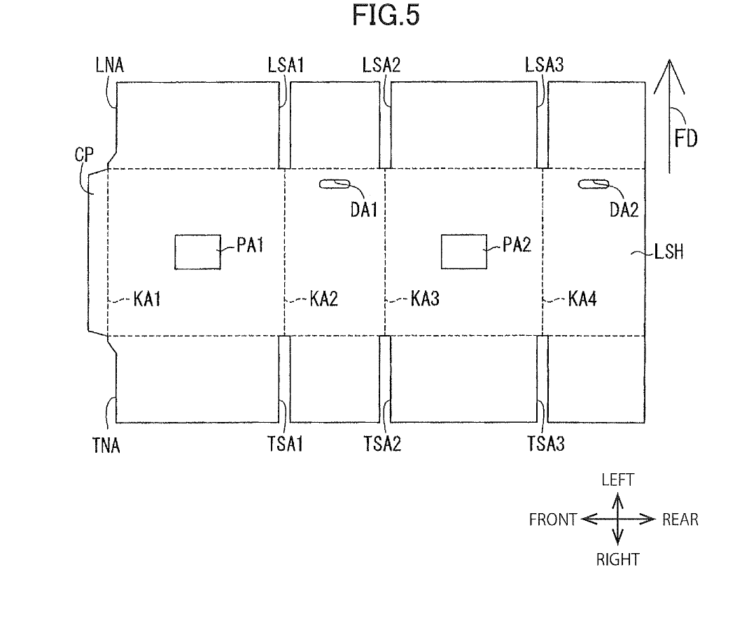

Next, an operation of the corrugated paperboard box making machine according to this embodiment of the present invention will be described. The corrugated paperboard box making machine 1 according to this embodiment can be selectively execute a normal order and a small-size order. In the normal order, one corrugated paperboard sheet SH fed from the sheet feeding device 2 is transferred from the die cutter 5 in the form of a normal corrugated paperboard sheet LSH illustrated in FIG. 5. In the small-size order, one corrugated paperboard sheet SH fed from the sheet feeding device 2 is cut by the die cutter, and transferred from the die cutter 5 in the form of the two small-size corrugated paperboard sheets SSH1, SSH2 illustrated in FIG. 6.

### <Execution of Normal Order>

With reference to FIGS. 1 to 5, an operation of the corrugated paperboard box making machine during execution of the normal order will be described. When an operator manually operates the order termination button 142 to terminate a current order, an operation of the corrugated paperboard box making machine 1 is stopped. During the stop of operation, each of the control devices 150 to 158 receives control comment information regarding a new order, from the lower-level management device 110. For producing and processing a corrugated paperboard sheet specified by the new order, settings of the sheet feeding device 2 and processing devices from the printing device 3 to the bundler 9 are changed, and processing members such as printing dies and the punching die 52 are replaced with suitable ones.

After completion of replacement of the processing members, the operator stacks corrugated paperboard sheets SH in the sheet feeding device 2. In this state, when the operator manually operates the sheet feed button 141 of the operation panel 140 to start execution of the new order, in response to the manual operation of the sheet feed button 141, the lower-level management device 110 instructs the drive control device 150 to drive the main drive motor MT and on a transport speed of a corrugated paperboard sheet specified by the new order. Thus, the main drive motor MT is driven at a rotational speed corresponding to the instructed transport speed, so that the sheet feeding device 2 starts a sheet feeding operation. Concurrently, the printing device 3, the slotter-creaser 4 and the die cutter 5 are activated according to the drive of the main drive motor MT.

Further, in response to the manual operation of the sheet feed button 141, the lower-level management device 110 instructs the folder-gluer control device 155 to drive the transport drive motor MF1 and the folding drive motor MF2, and on the transport speed of the corrugated paperboard sheet. Thus, each of the transport drive motor MF1 and the folding drive motor MF2 is driven at a rotational speed corresponding to the instructed transport speed, so that each of the transport belt 61 and the folding belt 64 of the folder-gluer 6 is circulatingly moved.

Furthermore, in response to the manual operation of the sheet feed button 141, the lower-level management device 110 instructs the inter-sheet spacing control device 156 to drive the roll drive motor MS1 and the conveyer drive motor MS2, and on the transport speed of the corrugated paperboard sheet. When the order instructed by the upper-level management device 100 is determined to be the normal order, the lower-level management device 110 instructs the inter-sheet spacing control device 156 on the same transport speed of the corrugated paperboard sheet as that instructed for other control device such as the folder-gluer control device 155. Thus, each of the roll drive motor MS1 and the conveyer drive motor MS2 is driven at a rotational speed corresponding to the instructed transport speed, so that, in the inter-sheet spacing device 7, the pair of transport rollers 70A, 70B and the upper transport roll 72 are rotated, and the transport conveyer 71 is circulatingly moved. During a period where the conveyer drive motor MS2 is driven, the inter-sheet spacing control device 156 receives a pulse signal from the pulse generator PG, and supplies speed detection information regarding the transport speed of the transport conveyer 71, to the lower-level management device 110.

In synchronization with a sheet feed cycle in which the sheet feeding device 2 feeds one corrugated paperboard sheet SH, the printing device 3 and the Blotter-creaser 4 operate to make print patterns PA1, PA2 on the normal corrugated paperboard sheet LSH illustrated in FIG. 5, and form creases KA1 to KA4, leading end slots LSAT to LSA3, trailing end slots TSA1 to TSA3, and a leading end cutout LNA and a trailing end cutout TNA for forming a joint flap CP, in the normal corrugated paperboard sheet LSH. Further, in synchronization with the sheet feed cycle, the die cutter 5 operates to form punched-out holes DA1, DA2 in the normal corrugated paperboard sheet LSH illustrated in FIG. 5.

The normal corrugated paperboard sheet LSH illustrated in FIG. 5 is supplied from the die cutter 5 to the folder-gluer 6. The folder-gluer 6 applies a glue on the joint flap CP and bends the normal corrugated paperboard sheet LSH to gluingly attach the joint flap CP to a counterpart area of the bent normal corrugated paperboard sheet LSH, thereby preparing a gluingly box-structured normal corrugated paperboard sheet LSH.

The lower-level management device 110 instructs the inter-sheet spacing control device 156 on the same transport speed of the corrugated paperboard sheet as that instructed for the folder-gluer control device 155, so that the transport rollers 70A, 70B, the transport conveyer 71 and the upper transport roll 72 transport the gluingly box-structured normal corrugated paperboard sheet LSH at the same transport speed as that in the folder-gluer 6, and supply it to the counter-ejector 8.

Based on a detection signal from the light sensor SN for detecting a passing-through of a corrugated paperboard sheet SH, the counter-ejector control device 157 counts the number of the normal corrugated paperboard sheets LSH supplied from the inter-sheet spacing device 7. The counter-ejector control device 157 controls drive of the ledge lifting-lowering motor MC1 to allow the main ledge 83 to be kept in a standby state at an upper position free of interference with the normal corrugated paperboard sheet LSH supplied from the inter-sheet spacing device 7, until the counted number reaches a predetermined value.

During a period where the counter-ejector control device 157 counts the number of the normal corrugated paperboard sheets LSH, the counter-ejector control device 157 receives speed detection information regarding the transport speed of the transport conveyer 71, from the lower-level management device 110. When the counted number reaches the predetermined value, the counter-ejector control device 157 controls a start timing of drive of the ledge lifting-lowering motor MC1 based on the received speed detection information. Through this control, a timing at which the main ledge 83 starts moving downwardly from the standby position is determined. Specifically, the downward-movement start timing of the main ledge 83 is determined such that, in the case where the normal order is executed, when the transport speed of the transport conveyer 71 to be equal to the transport speed of the transport belt 61 becomes greater than the transport speed of the transport belt 61, a period of time from a time when the counted number reaches the predetermined value through until the main ledge 83 starts moving downwardly is reduced, whereas, when the transport speed of the transport conveyer 71 becomes less than the transport speed of the transport belt 61, the period of time from the time when the counted number reaches the predetermined value through until the main ledge 83 starts moving downwardly is increased.

An operation of the counter-ejector control device 157 for forming the batch BT from stacked corrugated paperboard sheets is well known, as described, for example, in JP 2011-230432A, and therefore its description will be omitted. The batch BT formed by the counter-ejector 8 is transported to the bundler 9, and bundled by the bundler 9.

### <Execution of Small-Size Order>

With reference to FIGS. 1 to 4 and FIG. 6, an operation of the corrugated paperboard box making machine during execution of the small-size order will be described. When an operator manually operates the order termination button 142 to terminate the normal order, an operation of the corrugated paperboard box making machine 1 is stopped. During the stop of operation, each of the control devices 150 to 158 receives control comment information regarding the small-size order as a next order, from the lower-level management device 110. Settings of the sheet feeding device 2 and the processing devices from the printing device 3 to the bundler 9 are changed, and the processing members such as printing dies and the punching die 52 are replaced with suitable ones. For executing the small-size order, a special die capable of performing conventional punching and cutting of a corrugated paperboard sheet is used as the punching die 52.

After completion of replacement of the processing members, the operator stacks corrugated paperboard sheets SH in the sheet feeding device 2. In this state, when the operator manually operates the sheet feed button 141 of the operation panel 140 to start execution of the new small-size order, in response to the manual operation of the sheet feed button 141, the lower-level management device 110 instructs the drive control device 150 to drive the main drive motor MT and on a transport speed of a corrugated paperboard sheet specified by the small-size order. Thus, the main drive motor MT is driven at a rotational speed corresponding to the instructed transport speed, so that the sheet feeding device 2 starts a sheet feeding operation. Concurrently, the printing device 3, the slotter-creaser 4 and the die cutter 5 are activated according to the drive of the main drive motor MT.

Further, in response to the manual operation of the sheet feed button 141, the lower-level management device 110 instructs the folder-gluer control device 155 to drive the transport drive motor MF1 and the folding drive motor MF2, and on the transport speed of the corrugated paperboard sheet. Thus, each of the transport drive motor MF1 and the folding drive motor MF2 is driven at a rotational speed corresponding to the instructed transport speed, so that each of the transport belt 61 and the folding belt 64 of the folder-gluer 6 is circulatingly moved.

Furthermore, in response to the manual operation of the sheet feed button 141, the lower-level management device 110 instructs the inter-sheet spacing control device 156 to drive the roll drive motor MS1 and the conveyer drive motor MS2, and on the transport speed of the corrugated paperboard sheet. When the order instructed by the upper-level management device 100 is determined to be the small-size order, the lower-level management device 110 instructs the inter-sheet spacing control device 156 on a transport speed greater than that instructed for other control device such as the folder-gluer control device 155. Thus, each of the roll drive motor MS1 and the conveyer drive motor MS2 is driven at a rotational speed corresponding to the instructed higher transport speed, so that, in the inter-sheet spacing device 7, the pair of transport rollers 70A, 70B and the upper transport roll 72 are rotated, and the transport conveyer 71 is circulatingly moved. Based on the transport speed instructed for other control device such as the folder-gluer control device 155, and the speed-up rate stored in the program memory 120, the lower-level management device 110 calculates a transport speed of the transport conveyer 71, and instructs the inter-sheet spacing control device 156 on the calculated transport speed of the transport conveyer 71. In this embodiment, the transport speed to be instructed for the inter-sheet spacing control device 156 is set to a value 1.3 times greater than the transport speed to be instructed for the folder-gluer control device 155. The value 1.3 times of the speed-up rate is stored in the program memory 120. In this regard, the transport speed to be instructed for the inter-sheet spacing control device 156 is preferably set to a value 1.1 to 1.6 times greater than the transport speed to be instructed for the folder-gluer control device 155. During the period where the conveyer drive motor MS2 is driven, the inter-sheet spacing control device 156 receives a pulse signal from the pulse generator PG and supplies speed detection information regarding the transport speed of the transport conveyer 71, to the lower-level management device 110.

In synchronization with the sheet feed cycle of the sheet feeding device 2, the printing device 3 and the slotter-creaser 4 operate to make print patterns PB1 to PB4 and form creases KB 1 to KB4 in the corrugated paperboard sheet LSH, on and in the corrugated paperboard sheet SH illustrated in FIG. 6.

Further, in synchronization with the sheet feed cycle, the die cutter 5 operates to form punched-out holes DB1 to DB4 in the corrugated paperboard sheet SH illustrated in FIG. 6. Concurrently with the formation of the punched-out holes, the die cutter 5 forms leading end slots LSB1 to LSB3, trailing end slots TSB1 to TSB3, center slots CSB1 to CSB3, and a center cutout CNB, a leading end cutout LNB and a trailing end cutout TNB for forming joint flaps CP1, CP2, through punching. Further, concurrently with the formation of the punched-out holes, the die cutter 5 cuts the one corrugated paperboard sheet SH into two small-size corrugated paperboard sheets SSH1, SSH2, along a cut line CL through punching. The two small-size corrugated paperboard sheets SSH1, SSH2 have the same shape. That is, when the one corrugated paperboard sheet SH is equally cut into two small-size sheets, the center slots CSB1 to CSB3 aredivided into three trailing end slots each having the same shape as that of a respective one of the trailing end slots TSB1 to TSB3, and three leading end slots each having the same shape as that of a respective one of the leading end slots LSB1 to LSB3, and the center cutout CNB is divided into a trailing end cutout having the same shape of the trailing end cutout TNB, and a leading end cutout having the same shape as that of the leading end cutout LNB.

The small-size corrugated paperboard sheets SSH1, SSH2 illustrated in FIG. 6 are sequentially supplied from the die cutter 5 to the folder-gluer 6 in a continuous state without any space therebetween. The folder-gluer 6 applies a glue on the joint flaps CP1, CP2 and bends each of the small-size corrugated paperboard sheets SSH1, SSH2 to gluingly attach each of the joint flaps CP1, CP2 to a counterpart area of a respective one of the bent small-size corrugated paperboard sheets SSH1, SSH2, thereby preparing two gluingly box-structured small-size corrugated paperboard sheets SSH1, SSH2.

In this embodiment, the one corrugated paperboard sheet may be cut into three or more small-size sheets by the die cutter 5,

The lower-level management device 110 instructs the inter-sheet spacing control device 156 on a transport speed greater than that instructed for the folder-gluer control device 155, so that each of the transport rollers 70A, 70B, the transport conveyer 71 and the upper transport roll 72 are driven at a transport speed greater than that in the folder-gluer 6. When a part of the gluingly box-structured small-size corrugated paperboard sheet SSH1 is transferred from the folder-gluer 6, and nipped between the transport rollers 70A, 70B, the small-size corrugated paperboard sheet SSH1 is quickly accelerated. When the small-size corrugated paperboard sheet SSH1 is being accelerated, a remaining part of the small-size corrugated paperboard sheet SSH1 located between the transport belt 61 and the folding belt 64 is transported while slipping on the two belts 61, 64. Due to the speed-up of the small-size corrugated paperboard sheet SSH1, a spacing is formed between the small-size corrugated paperboard sheet SSH1 and the trailing small-size corrugated paperboard sheet SSH2, i.e., the two small-size corrugated paperboard sheets are spaced apart from each other.

The small-size corrugated paperboard sheet SSH1 is further increased in speed while being transported by the transport conveyer 71, and then when it is nipped between the transport conveyer 71 and the upper transport roll 72, the transport speed thereof reaches a value close to the transport speed instructed by the lower-level management device 110. The small-size corrugated paperboard sheet SSH1 is transported while being nipped between the transport conveyer 71 and the upper transport roll 72, and supplied to the counter-ejector 8.

As with the small-size corrugated paperboard sheet SSH1, when the trailing small-size corrugated paperboard sheet SSH2 is nipped between the transport rollers 70A, 70B, it is quickly accelerated, and then further increased in speed while being transported by the transport conveyer 71. When the small-size corrugated paperboard sheet SSH2 is nipped between the transport conveyer 71 and the upper transport roll 72, the transport speed thereof reaches a value close to the transport speed instructed by the lower-level management device 110. At a time when a trailing edge of the small-size corrugated paperboard sheet SSH1 passes through between the transport conveyer 71 and the upper transport roll 72, a given spacing is formed between the two small-size corrugated paperboard sheets SSH1, SSH2. This given spacing formed between the two small-size corrugated paperboard sheets is intended to, when the leading small-size corrugated paperboard sheet SSH1 falls in the receiving space defined by the leading-edge contact plate 81 and the correction plate 82 of the counter-ejector 8, prevent the trailing small-size corrugated paperboard sheet SSH2 from colliding with the leading small-size corrugated paperboard sheet SSH1.

Based on a detection signal from the light sensor SN, the counter-ejector control device 157 counts the number of the small-size corrugated paperboard sheets transported in the inter-sheet spacing device 7. The counter-ejector control device 157 controls drive of the ledge lifting-lowering motor MC1 to allow the main ledge 83 to be located at the standby position until the counted number reaches a predetermined value.

During a period where the counter-ejector control device 157 counts the number of the small-size corrugated paperboard sheets, the counter-ejector control device 157 receives speed detection information regarding the transport speed of the transport conveyer 71, from the lower-level management device 110. When the counted number reaches the predetermined value, the counter-ejector control device 157 controls a start timing of drive of the ledge lifting-lowering motor MC1, based on the received speed detection information, and the speed correction value stored in the program memory 120. Through this control, a timing at which the main ledge 83 starts moving downwardly from the standby position is determined. Specifically, in the case where the small-size order is executed, the transport speed of the transport conveyer 71 is set to a value greater than the transport speed of the transport belt 61. Thus, the downward-movement start timing of the main ledge 83 is determined to allow the period of time from a time when the counted number reaches the predetermined value through until the main ledge 83 starts moving downwardly, to become less than that during the normal order. Under an influence of a low transport speed of the transport belt 61, an actual transport speed of the small-size corrugated paperboard sheet being transported in the inter-sheet spacing device 7 can be reduced to a value less than the transport speed of the transport conveyer 71. As above, an actual transport speed of the small-size corrugated paperboard sheet tends to become less than the transport speed of the transport conveyer 71. This tendency prominently appears as a length of the small-size corrugated paperboard sheet in the transport direction becomes longer. In this embodiment, the program memory 120 preliminarily stores therein the speed correction value to cope with the small-size order. The speed correction value is information for correcting speed detection information indicative of the transport speed of the transport conveyer 71 to obtain a speed equivalent to an actual transport speed of the small-size corrugated paperboard sheet.

The counter-ejector 8 forms the batch BT from stacked small-size corrugated paperboard sheets, and the bundler 9 bundles the batch BT transferred from the counter-ejector 8.

### <<Effects of Embodiment>>

In this embodiment, the inter-sheet spacing device 7 is disposed between the folder-gluer 6 and the counter-ejector 8. Thus, in the case where the small-size order is executed, even if each of the small-size corrugated paperboard sheets SSH1, SSH2 undergoes a change to an oblique posture when it is accelerated by the transport rollers 70A, 70B and the transport conveyer 71, the change to an oblique posture never exerts a negative influence on bending accuracy in the folder-gluer 6, because each of the small-size corrugated paperboard sheets SSH1, SSH2 has already been bent and glued in the folder-gluer 6. In addition, even if each of the small-size corrugated paperboard sheets SSH1, SSH2 undergoes a change to an oblique posture due to the speed-up in the inter-sheet spacing device 7, the small-size corrugated paperboard sheets SSH1, SSH2 having an oblique posture are posturally adjusted by the leading-edge contact plate 81 and the correction plate 82, so that there is no risk of developing problems with production of corrugated paperboard sheets.

Generally, as a cause for the phenomenon that a small-size corrugated paperboard sheet undergoes a change to an oblique posture due to speed-up for spacing, there are various possible factors such as a shape and paper quality of a corrugated paperboard sheet. For example, as illustrated in FIG. 6, regarding a shape of a small-size corrugated paperboard sheet, a sheet length in a transport direction is significantly less than a sheet width in a direction perpendicular to the transport direction, and thereby an area of the small-size corrugated paperboard sheet coming into contact with transport means to receive a transport force therefrom is reduced, so that a transport posture of the small-size corrugated paperboard sheet during transport becomes more unstable than a transport posture of a normal corrugated paperboard sheet. When the small-size corrugated paperboard sheet having an unstable transport posture is accelerated for spacing, a transport force received from the transport means by the small-size corrugated paperboard sheet at different contact positions in the direction perpendicular to the transport direction largely varies. Thus, due to the variation of the transport force at the different contact positions, the small-size corrugated paperboard sheet is more likely to undergo a change to an oblique posture. Further, as illustrated in FIG. 6, regarding a shape of a small-size corrugated paperboard sheet, the small-size corrugated paperboard sheet is asymmetric with respect to a reference line RL extending parallel to the transport direction and passing a center position of the small-size corrugated paperboard sheet in the direction perpendicular to the transport direction. Thus, when the small-size corrugated paperboard sheet is being transported by the transport means, a weight distribution and air resistance of the small-size corrugated paperboard sheet in the direction perpendicular to the transport direction become imbalanced or uneven. Due to unevenness in the weight distribution and air resistance, the small-size corrugated paperboard sheet is more likely to undergo a change to an oblique posture. In this embodiment, the small-size corrugated paperboard sheets SSH1, SSH2 which are likely to undergo a change to an oblique posture are spaced apart from each other by the inter-sheet spacing device 7 disposed downstream of the folder-gluer 6, so that it becomes possible to completely eliminate a situation where the spacing operation exerts a negative influence on bending accuracy of the small-size corrugated paperboard sheets SSH1, SSH2 in the folder-gluer 6.

In this embodiment, the inter-sheet spacing control device 156 increases the rotational speed of each of the roll drive motor MS1 and the conveyer drive motor MS2 by a certain rate to allow the transport speed of each of the small-size corrugated paperboard sheets SSH1, SSH2 in the inter-sheet spacing device 7 to become greater than the transport speed of each of the small-size corrugated paperboard sheets SSH1, SSH2 in the folder-gluer 6. The speed-up of the inter-sheet spacing device 7 eliminates a need for reducing a transport speed of the corrugated paperboard sheet in each of the folder-gluer 6 and a processing device disposed upstream of the folder-gluer 6 in the transport direction FD, such as the die cutter 5, so that it becomes possible to maintain a corrugated paperboard sheet production speed at a high value.

In this embodiment, the counter-ejector control device 157 controls a start timing of drive of the ledge lifting-lowering motor MC1 to allow a timing at which the main ledge 83 starts moving downwardly to become earlier along with an increase in transport speed of the small-size corrugated paperboard sheets SSH1, SSH2 in the inter-sheet spacing device 7. Thus, even in a situation where the small-size corrugated paperboard sheets SSH1, SSH2 are increased in transport speed, the counter-ejector 8 can reliably separate a given number of the small-size corrugated paperboard sheets, according to the above drive start timing control.

In this embodiment, the transport speed of the transport conveyer 71 is detected based on a pulse signal from the pulse generator PG. Based on speed detection information indicative of the detected transport speed of the transport conveyer 71, and the speed correction value, the counter-ejector 8 controls the start timing of drive of the ledge lifting-lowering motor MC1. Through this control, a timing at which the main ledge 83 starts moving downwardly from a standby position is determined. Specifically, the counter-ejector 8 corrects the detected transport speed of the transport conveyer 71 by the speed correction value, and determine the timing at which the main ledge 83 starts moving downwardly from the standby position, based on the corrected transport speed equivalent to an actual transport speed of the small-size corrugated paperboard sheet. Thus, even if there is a difference between an actual transport speed of the small-size corrugated paperboard sheet being transported by the transport conveyer 71 and the detected transport speed of the transport conveyer 71, the downward movement of the main ledge can be started without causing collision with the small-size corrugated paperboard sheet supplied from the inter-sheet spacing device 7.

In this embodiment, the pair of transport rollers 70A, 70B are arranged adjacent to the outlet of the folder-gluer 6. Based on this arrangement of the two transport rollers, a nip pressure is applied to a corrugated paperboard sheet just after being transferred from the folder-gluer 6. This nip pressure makes it possible to reliably press the bent creases KB1 to KB4 and the glued areas of the joint flaps CP1, CP2 in an early stage, thereby quickly stabilizing a bonded state of the corrugated paperboard sheet.

### [Modifications]

An advantageous embodiment of the invention has been shown and described. It is obvious to those skilled in the art that various changes and modifications may be made therein without departing from the spirit and scope thereof as set forth in appended claims.

(1) In the above embodiment, in the case where the small-size order is executed in which one corrugated paperboard sheet is cut into a plurality of small-size sheets, as long as the transport speed of the small-size corrugated paperboard sheet in the inter-sheet spacing device 7 is set to a value greater than that in the folder-gluer 6, any suitable setting may be employed. That is, the transport speed in the inter-sheet spacing device 7 may be set to a value greater than the transport speed in the folder-gluer 6. Alternatively, the transport speed in the folder-gluer 6 may be set to a value less than that during the normal order. Alternatively, the two types of settings may be employed in combination.

Further, in the inter-sheet spacing device 7 and the folder-gluer 6, the speed adjustment may be controlled by adjusting a motor speed of the transport drive motor, or by manually or automatically switching between two types of gear trains having different rotation transmission ratios.

Further, an increment in speed by which the transport speed of the small-size corrugated paperboard sheet in the inter-sheet spacing device 7 becomes greater than that in the folder-gluer 6 is a value capable of forming a given spacing between a leading small-size corrugated paperboard sheet and a trailing small-size corrugated paperboard sheet, to prevent the trailing small-size corrugated paperboard sheet from colliding with the leading small-size corrugated paperboard sheet when the leading small-size corrugated paperboard sheet falls in an inside of the counter-ejector 8.

(2) In the above embodiment, in the case where the small-size order is executed, the die cutter 5 is configured to form slots in opposite ends and a central region of one corrugated paperboard sheet SH by punching, and cut the resulting corrugated paperboard sheet SH into two small-size corrugated paperboard sheets SSH1, SSH2. However, the present invention is not limited thereto. For example, the corrugated paperboard box making machine may comprises a slotter unit configured to form slots not only in opposite ends of one corrugated paperboard sheet but also in a central region of the corrugated paperboard sheet, and dedicated cut means configured to cut one corrugated paperboard sheet into two small-size corrugated paperboard sheets. In this modification, it becomes possible to eliminate a need for replacement with the punching die of the die cutter for producing small-size corrugated paperboard sheets, thereby significantly shortening a setup time in advance of execution of the small-size order. In this regard, a slotter unit configured to form slots in a central region of a corrugated paperboard sheet is publicly known, as described, for example, in JP 2002-067190A.

(3) In the above embodiment, a transport section of the inter-sheet spacing device 7 comprises the pair of transport rollers 70A, 70B, the transport conveyer 71 and the upper transport roll 72. However, the present invention is not limited thereto, but the transport section of the inter-sheet spacing device may be variously configured. For example, the inter-sheet spacing device may be comprised of a large number of transport rolls disclosed in the Patent Document 1. Alternatively, the inter-sheet spacing device may comprise a pair of transfer conveyers arranged in an up-down direction, or may be one transport conveyer and a suction mechanism disposed just below the conveyer to suction-hold a corrugated paperboard sheet. Alternatively, the inter-sheet spacing device may comprise a transport conveyer, a pair of transfer rolls disposed on an outlet side of the transport conveyer, and an upper transport roll disposed just above an inlet side of the transport conveyer.

(4) In the above embodiment, the length of the transport conveyer 71 in the transport direction FD is set to be greater than a transport directional (FD) maximum length of a small-size corrugated paperboard sheet produceable by the corrugated paperboard box making machine 1. However, the present invention is not limited thereto. As long as a given spacing between leading and trailing small-size corrugated paperboard sheets can be formed by increasing the transport speed of the leading small-size corrugated paperboard sheet, the length of the transport conveyer 71 may be equal to or less than the transport directional (FD) maximum length of the produceable small-size corrugated paperboard sheet.

(5) In the above embodiment, the lower-level management device 110 is configured, based on the transport speed instructed for a control device such as the folder-gluer control device 155, and the speed-up rate stored in the program memory 120, to calculate the transport speed of the transport conveyer 71, and instruct the inter-sheet spacing control device 156 on the calculated transport speed of the transport conveyer 71. However, the present invention is not limited thereto. For example, the corrugated paperboard box making machine 1 may be configured to preliminarily set the transport speed of the transport belt 61 and the transport speed of the transport conveyer 71 to allow a given spacing to be formed between small-size corrugated paperboard sheets specified by the small-size order, and store the preset transport speeds in a storage section in association with the small-size order, wherein the lower-level management device is configured, when the small-size order is executed, to read the transport speeds associated with the small-side order, and instruct the folder-gluer control device and the inter-sheet spacing control device on the read transport speeds.

(6) In the above embodiment, the counter-ejector control device 157 is configured to correct, by the speed correction value, the transport speed of the transport conveyer 71 calculated based on speed detection information regarding the transport speed of the transport belt 61, and the speed-up rate, and, based on the corrected transport speed of the transport conveyer 71, determine a start timing of moving the main ledge 83 downwardly. However, the present invention is not limited thereto. For example, in the case where the transport speed of the transport belt 61, the transport speed and corrected transport speed of the transport conveyer 71 are preliminarily stored in a storage section in association with the small-size order, the counter-ejector control device may be configured to determine the start timing of the downward movement of the main ledge 83 based on the corrected transport speed read from the storage section. The corrected transport speed is obtained by correcting the calculated transport speed of the transport conveyer 71 using the speed correction value.

(7) In this embodiment, the corrugated paperboard box making machine 1 is configured to drive the sheet feeding device 2, the printing device 3, the slotter-creaser 4 and the die cutter 5 by the one main drive motor MT. However, the present invention is not limited thereto. For example, the processing devices such as the sheet feeding device and the printing device may be configured to be driven by a plurality of drive motors coupled to them, respectively.

What is claimed is:

1. A corrugated paperboard box making machine comprising:
a cutting device for cutting one corrugated paperboard sheet, to which a plurality of types of processes are applied in sequence while the one corrugated paperboard sheet is transported in a predetermined transport direction, into a plurality of small-size corrugated paperboard sheets along a direction perpendicular to the predetermined transport direction;
a folder-gluer for bending and gluing each of the small-size corrugated paperboard sheets, while the small-size corrugated paperboard sheets are transported;
a counter-ejector for stacking the glued small-size corrugated paperboard sheets to form a batch having a predetermined number of the glued small-size corrugated paperboard sheets; and
an inter-sheet spacing device for spacing the small-size corrugated paperboard sheets apart from each other, between the folder-gluer and the counter-ejector, the inter-sheet spacing device comprising a transport section for transporting the small-size corrugated paperboard sheets from the folder-gluer to the counter-ejector, and a speed adjustment section for adjusting a transport speed in at least one of the folder-gluer and the transport section so that the transport speed in the transport section becomes greater than that in the folder-gluer.

2. The corrugated paperboard box making machine according to claim 1, wherein the speed adjustment section of the inter-sheet spacing device adjusts the transport speed in the transport section so as to become greater than the transport speed in the folder-gluey.

3. The corrugated paperboard box making machine according to claim 2, wherein the speed adjustment section of the inter-sheet spacing device adjust the transport speed in the transport section so that the transport speed in the transport section becomes 1.1 to 1.6 times greater than that in the folder-gluer.

4. The corrugated paperboard box making machine according to claim 1, wherein the transport section of the inter-sheet spacing device comprises:
a pair of transport rolls disposed on an outlet side of the folder-gluer from which the small-size corrugated paperboard sheet is transferred outside the folder-gluer;
a transport conveyer for transporting the small-size corrugated paperboard sheet transferred from the pair of transport rolls, to the counter-ejector; and
a drive section for driving each of the pair of transport rolls and the transport conveyer.

5. The corrugated paperboard box making machine according to claim 4, wherein a length of the transport conveyer is set to be greater than a maximum length of a produceable small-size corrugated paperboard sheet in the transport direction.

6. The corrugated paperboard box making machine according to claim 4, wherein the counter-ejector comprises:
a ledge disposed in a liftable and lowerable manner so as to separate the stacked small-size corrugated paperboard sheets as a batch having a predetermined number of the small-size corrugated paperboard sheets;
a lifting-lowering drive section for lifting and lowering the ledge; and
a lifting-lowering control section for controlling the lifting-lowering drive section so as to adjust a timing at which the ledge starts moving downwardly, in conformity to the adjustment of the transport speed by the speed adjustment section.

7. The corrugated paperboard box making machine according to claim 6, wherein the lifting-lowering control section of the counter-ejector adjusts the timing at which the ledge starts moving downwardly, in accordance with an actual transport speed of the small-size corrugated paperboard sheet obtained by correcting detection information regarding a transport speed of the transport conveyer, using a predetermined speed correction value.

8. The corrugated paperboard box making machine according to claim 7, wherein the speed correction value is set to a larger value along with an increase in length of the small-size corrugated paperboard sheet in the transport direction.

9. An inter-sheet spacing device for use in a corrugated paperboard box making machine, the corrugated paperboard box making machine comprising:
a cutting device for cutting one corrugated paperboard sheet, to which a plurality of types of processes are applied in sequence while the one corrugated paperboard sheet is transported in a predetermined transport direction, into a plurality of small-size corrugated paperboard sheets along a direction perpendicular to the predetermined transport direction;
a folder-gluer for bending and gluing each of the small-size corrugated paperboard sheets, while the small-size corrugated paperboard sheets are transported; and
a counter-ejector for stacking the glued small-size corrugated paperboard sheets to form a batch having a predetermined number of the glued small-size corrugated paperboard sheets,
wherein the inter-sheet spacing device spaces the small-size corrugated paperboard sheets apart from each other, between the folder-gluer and the counter-ejector, the inter-sheet spacing device comprising a transport section for transporting the small-size corrugated paperboard sheets from the folder-gluer to the counter-ejector, and a speed adjustment section for adjusting a transport speed in at least one of the folder-gluey and the transport section so that the transport speed of the transport section becomes greater than that in the folder-gluer.
